(19) United States
(12) Patent Application Publication
(10) Pub. No.: US 2005/0194753 A1
(43) Pub. Date: Sep. 8, 2005

(54) Snowboard Binding

(76) Inventors: Richard J. Craven JR., Brighton, MI (US); Annette E. Craven, Brighton, MI (US)

Correspondence Address: FOSTER, SWIFT, COLLINS & SMITH, P.C., 313 SOUTH WASHINGTON SQUARE, LANSING, MI, 48933, US

(21) Appl. No.: 10/708,499

(22) Filed: Mar. 8, 2004

(51) Int. Cl. B62B 9/04

(52) U.S. Cl. 280/14.24

(57) ABSTRACT

A snowboard binding apparatus allows a user to rotate a forward binding to a comfortable position upon, and only upon, the removal of the user's boot from a rearward binding. The apparatus includes a first binding assembly having an actuator cover and configured to be attached to a top surface of a snowboard and a second binding assembly having a rotating plate. The second binding assembly is operably connected to the first binding assembly and configured to be attached to a top surface of the snowboard at a spaced longitudinal distance from said first binding assembly. The rotating plate is rotatable about an axis perpendicular to the top surface of the snowboard upon removal of weight from the actuator cover, while the first binding assembly remains stationary.

### BACKGROUND OF INVENTION

1. Field of the Invention

The present invention generally relates to a snowboard binding and particularly to a snowboard binding assembly adapted to attach to a snowboard and configured to allow rotation of one binding relative to the longitudinal axis of the snowboard while a user's foot is secured to that binding, when, and only when, the user's other foot is removed from the other binding.

2. Discussion of Related Art

Snowboarding has increased in popularity over the past several years. Naturally, there have been efforts to improve not only the performance of the snowboard, but also its ease of use and comfort.

For example, a snowboarder is typically bound to the snowboard by placing both feet on the board at particular (generally perpendicular) angular orientation relative to the longitudinal axis of the board. Once a snowboarder reaches a ski lift or other location on relatively flat terrain, he must remove one or both of his feet from the board. If he removes one foot from the board, it is usually his rear foot to allow him to propel across the snow similar to skateboarding. The foot that remains bound to the board is typically at an awkward angle (typically substantially perpendicular) relative to the longitudinal axis of the board, making it very difficult and uncomfortable for the snowboarder to maneuver. This awkward positioning, may not only cause discomfort but also stress to body joints such as the knee and ankle of the bound leg. Alternatively the snowboarder may remove both feet from the board and carry the board to the new location. This effort can be time consuming and frequently lift operators will not allow a loose snowboard on the lift. Snowboard bindings are currently available that attempt to solve some of these problems. Some allow a user to adjust or set one or both of the bindings at a particular angle by rotating the binding and locking the binding into the desired position prior to use. Unfortunately, once the bindings are locked into place, a snowboarder must remove his boots from the board to readjust the setting. This type of binding is thus only practical for rare setting changes. Other bindings are configured to allow free-floating rotation of the bindings. These types of bindings enable a user to continuously rotate his feet to various angular orientations relative to the board while in use without removing the snowboarder's feet from the bindings. This type of binding appears to apply to advanced snowboarders since it would seem difficult to maintain a stable condition while snowboarding.

Still other snowboard bindings are available that provide the ability to rotate the orientation of the snowboarder's boot within the binding by a manual release. This manual release and lock type of binding is time consuming to operate as it requires additional manipulation of some type of release mechanism such as a pull lever, clip, pin or the like. These types of bindings may require the snowboarder to bend down to actuate a pull clip or lever located at the binding. Awkward attempts to remedy this provide a tether line or cord that is connected to the pull lever located in a position accessible to the user. For example, in some such bindings, the snowboarder fastens the tether to his or her leg, which could present an undesired interference with the snowboarder's leg movements while snowboarding.

Thus, there is a desire and need in the art for a snowboard binding, which will allow the snowboarder to quickly and easily reposition the angle of at least one of his feet while not in use. This capability would improve maneuverability of the snowboard as the user moves from one location to another. There is a further desire and need to provide a rotatable snowboard binding that allows rotation of at least one of the bindings relative to the snowboard without the need to manually actuate a lever or pull a cord or tether line.

### SUMMARY OF INVENTION

Accordingly, the present invention provides a snowboard binding connectable to a snowboard that allows for rotation of one foot secured to the binding assembly upon, and only upon, the removal of the other foot from the other binding assembly. This configuration provides a quick and easy method of repositioning the angle of the foot that remains secured to the binding while allowing the other foot to assist in maneuvering the snowboard from one location to another in a skateboarding type manner.

In one embodiment of the present invention, a snowboard binding apparatus includes a first binding assembly having an actuator cover and a second binding assembly having a rotating plate operably connected to the first binding assembly. The first binding assembly and the second binding assembly are configured to connect to a top surface of a snowboard at a spaced longitudinal distance from each other. The rotating plate is rotatable about an axis perpendicular to the top surface of the snowboard upon removal of weight from the actuator cover, while the first binding assembly remains stationary.

In another embodiment of the present invention, a snowboard binding apparatus includes a first binding assembly having an actuator cover and a top plate attached to a first base plate. A second binding assembly is included, having a rotating plate rotatably connected to a second base plate. The first base plate and second base plate are both configured to attach to a top surface of a snowboard and a connecting member operably connects the first binding assembly to the second binding assembly. The actuator cover is movable between a first position and a second position. In the first position, a top surface of the actuator cover is positioned substantially above a bottom portion of a boot binding that is connected to the first binding assembly. In the second position, the top surface of the actuator cover is positioned substantially flush with the bottom portion of the boot binding. The rotating plate is rotatable about an axis perpendicular to the snowboard when the actuator cover is in the first position.

In yet another embodiment of the present invention, a snowboard binding apparatus includes a first binding assembly having an actuator cover and a first base plate configured to be attached to a top surface of a snowboard. A second binding assembly includes a second base plate and a release lever. The release lever is operably connected to the first binding assembly and the second base plate is configured to attach to the top surface of the snowboard at a longitudinally spaced distance from the first base plate. A connecting member operably connects the first binding assembly to the second binding assembly and the second binding assembly further includes a rotating plate. The rotating plate is rotatable about an axis perpendicular to the top surface of the snowboard, upon removal of weight from the actuator cover.

Other features of the present invention will become more apparent to persons having ordinary skill in the art to which the present invention pertains from the following description and claims taken in conjunction with the accompanying figures.

### BRIEF DESCRIPTION OF DRAWINGS

The foregoing features, as well as other features, will become apparent with reference to the description and figures below, in which like numerals represent like elements, and in which:

FIG. 1 is a perspective view of a snowboard binding apparatus of the present invention attached to a snowboard;

FIG. 2 is an exploded view of a first binding assembly of the present invention;

FIG. 3 is a cross sectional view of a first binding assembly of the present invention shown without the actuator assembly installed;

FIG. 4 is a side view of an actuator assembly of the present invention;

FIG. 5 is a sectional view of a first binding assembly of the present invention shown with the actuator assembly installed;

FIG. 6 is an exploded view of a second binding assembly of the present invention;

FIG. 7 is a cross sectional view of a second binding assembly of the present invention shown without the release mechanism installed;

FIG. 8 is a side view of a release mechanism of the present invention;

FIG. 9 is a cross sectional view of a second binding assembly of the present invention shown with the release mechanism installed; and

FIG. 10 is a top view of the rotating plate attached to the second base plate.

### DETAILED DESCRIPTION

The present invention provides a snowboard binding apparatus connectable to a typical snowboard available in the art without modification. The snowboard binding apparatus of the present invention allows for rotation of one binding assembly upon, and only upon, the removal of the user's foot from the other binding assembly. The apparatus of the present invention is configured to provide a quick and easy method of repositioning the angle of the user's forwardly placed foot, while allowing the rearwardly placed foot to be removed from the snowboard binding. This allows the user to use his free foot to assist in maneuvering the snowboard from one location to another in a skateboarding type manner.

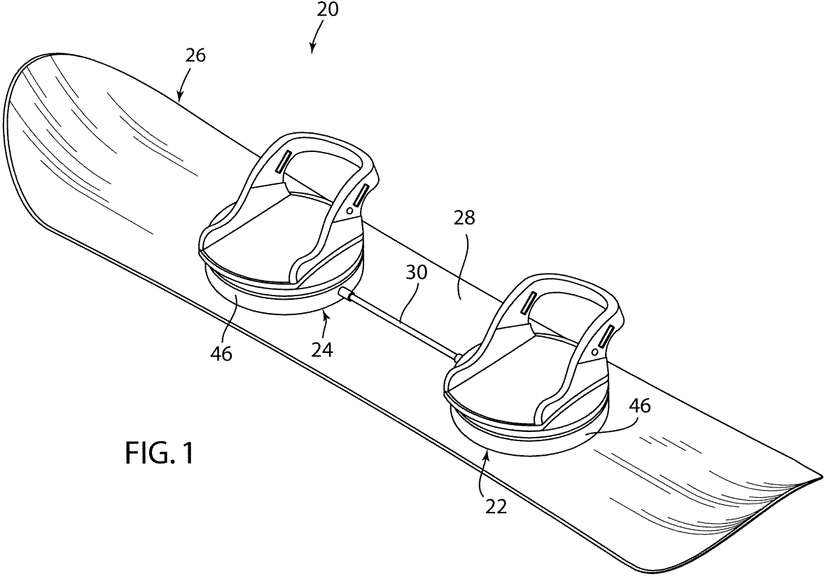

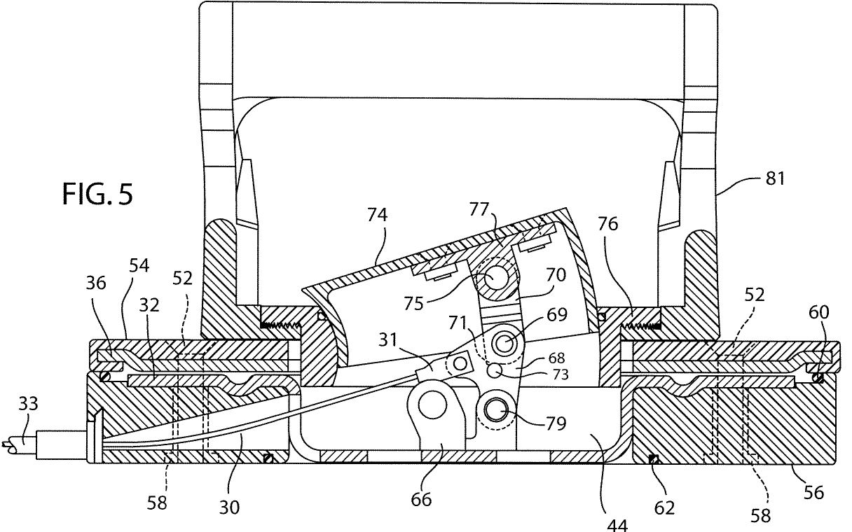

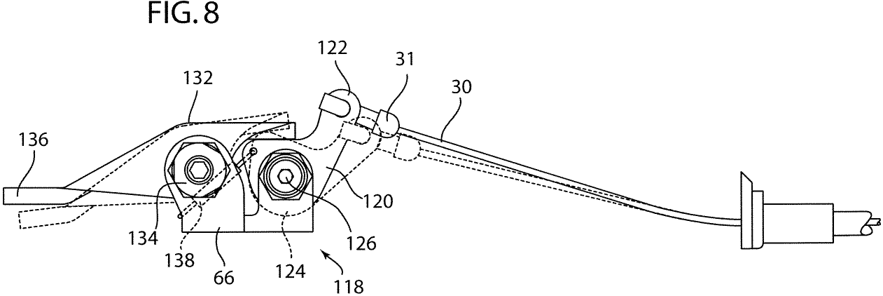

As shown in FIG. 1, a snowboard binding apparatus 20 of the present invention includes a first binding assembly 22 (static binding) and a second binding assembly 24 (rotating binding). Both first binding assembly 22 and second binding assembly 24 are configured to attach to a typical snowboard 26, available in the art and without modification. First binding assembly 22 is configured to attach to a top surface 28 of snowboard 26 on a rearward portion of snowboard 26, and second binding assembly 24 is configured to attach to top surface 28 on a forward portion of snowboard 26. A connecting member 30 is operably connected to first binding assembly 22 on one end and to the second binding assembly 24 on an opposite end. Connecting member 30 may include a typical cable assembly known in the art and may include end fittings 31 as shown in FIGS. 5, 8 & 9. A sheath 33 may be configured to fit around the cable portion of connecting member 30 to protect it from intrusion of snow or other elements that may interfere with its function. Connecting member 30 may be configured in length to allow connecting member 30 to move with the flexure of the snowboard during use.

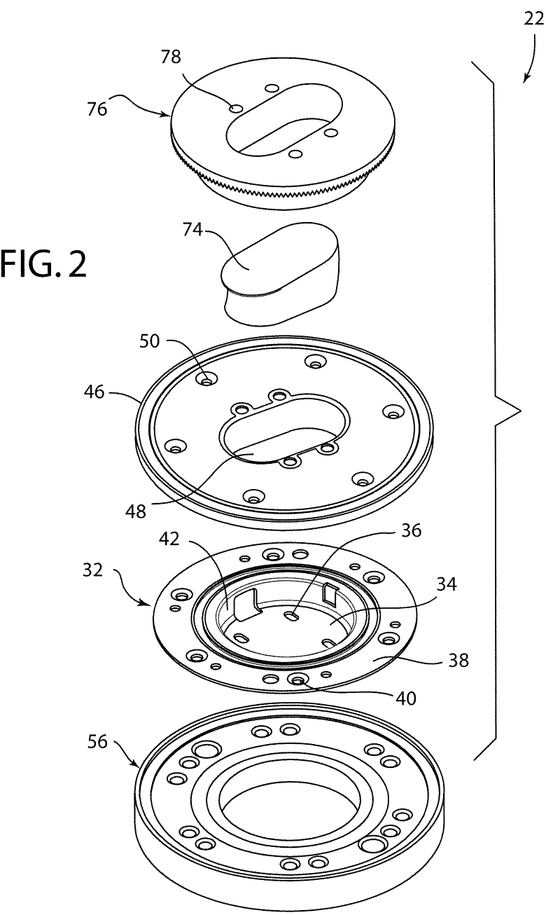

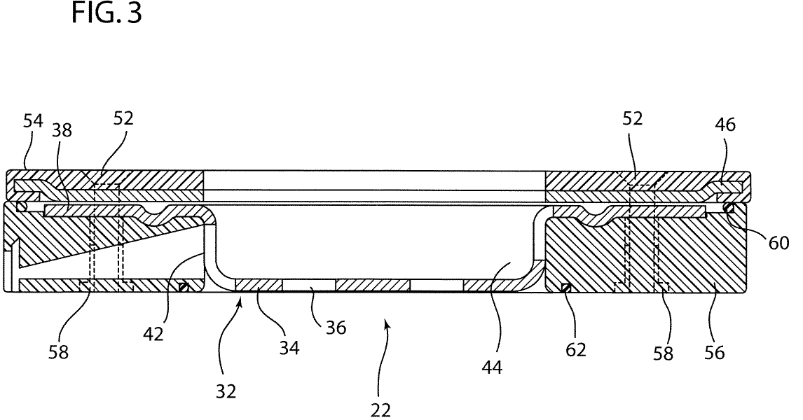

As shown in FIGS. 2 and 3, first binding assembly 22 may include a first base plate 32 having a substantially flat bottom portion 34 including a plurality of holes 36 configured to correspond to a typical hole-pattern on a snowboard. This allows for easy adaptability of the snowboard binding of the present invention to current snowboard designs. First base plate 32 may also include an upper radially and horizontally extending portion 38 having a plurality of holes 40 and a vertically and downwardly extending radial wall 42 connecting upper portion 38 and bottom portion 34. Vertically extending radial wall 42 and bottom portion 34 define an inner space 44 for which operable components of first binding assembly 22 are positioned (discussed in greater detail below). Top plate 46, having a centrally located aperture 48, is attachable to upper portion 38 at a plurality of holes 50, which correspond to plurality of holes 40 in first base plate 32. Typical attachment methods known in the art may be used such as bolts 52 shown in FIG. 3. First base plate 32 and top plate 46 may be constructed of a metallic material and preferably a stainless steel. Other possible materials may include a heat-treated carbon steel, such as 4130, 4140, or high strength low carbon alloys such as 950 to 980 HSLA with a rust preventative. Other materials may be used that provide the necessary strength and durability to perform under the wear that a typical snowboard incurs.

An overmold layer 54 may also be included as shown in FIG. 3, molded integrally over top plate 46 to help protect top plate 46 from possible damage during use. Overmold layer 54 may include materials such as Polypropylene, Polyethylene, Nylon, Acetyl or any other suitable material known in the art. A protective spacer assembly 56 may also be included that fits radially around the exterior of first binding assembly 22 as shown in FIGS. 2 and 3. Protective spacer assembly 56 is configured to provide an outer shield to prevent snow and other materials from intruding into the binding assembly and may be constructed of a plastic material such as Polypropylene, Polyethylene, Nylon, Acetyl or other suitable rigid material. Protective spacer assembly 56 may include a plurality of threaded spacer bushings 58 located radially on protective spacer assembly 56 and positioned directly beneath upper portion 38 and plurality of holes 40. Bolts 52, which are used to connect top plate 46 to upper portion 38, may extend downwardly into spacer bushings 58 as shown in FIG. 3, securing protective spacer 56 in position. Spacer bushings 58 are also configured to help support upper portion 38. Protective spacer assembly 56 may also include an upper O-ring 60 and a lower O-ring 62 configured to prevent intrusion of snow and other materials into first binding assembly 22.

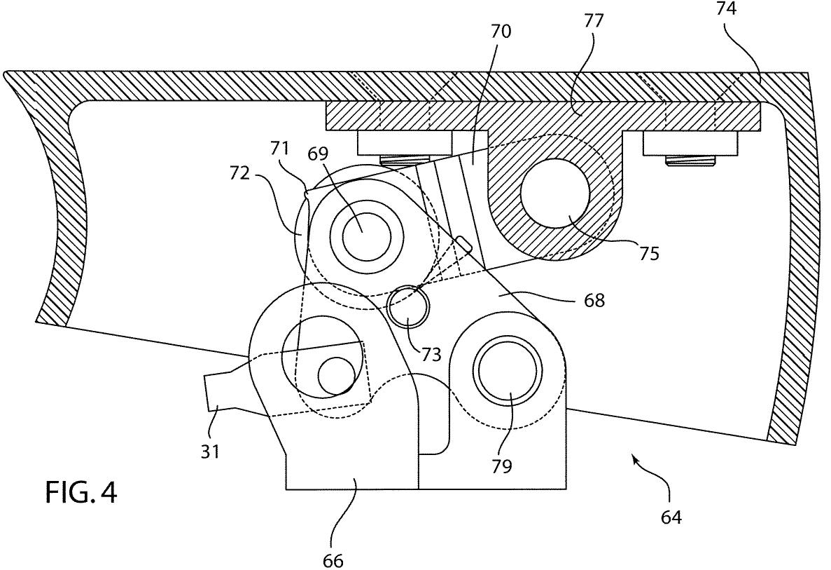

An actuator assembly 64 (FIG. 4) may be positioned within inner space 44 and operably connected to connector assembly 30 as shown in FIG. 5. Actuator assembly 64 may include a mounting bracket 66 connectable to first base plate 32 by welds (arc, mig or resistance), or other known attachment methods. A lower linkage 68 is pivotally connected to mounting bracket 66 at pivot 79 and to an actuator link 70 at pivot joint 69. The connecting member end fitting 31 may be configured to be mechanically through form or attached to lower linkage 68 with typical threaded fasteners, rivets, z-fittings or the like (z-fitting attachment shown). Actuator link 70 includes a lip portion 71 configured to interface with a locking member 73 (such as a half pierce, pin or the like) when actuator link 70 is rotated to an up position as shown in FIG. 5. The locking member may include a pin, half pierce or the like. An actuator cover 74 may be connected to a yoke member 77 with mechanical fasteners or other known attachment methods, which in turn is pivotally connected to actuator link 70 at pivot attachment 75. A clockspring 72 may also be operably connected to lower linkage 68 and actuator link 70, and configured to bias actuator link 70 into a substantially vertical or “up”-position as shown in FIG. 5, when no weight is exerted on actuator assembly 64. In the up position, lower linkage 68 is rotated up and to an off-center position (approximately 7 degrees as shown), and lip 71 is positioned in an interference position with locking member 73. In this position, the actuator assembly 64 cannot be actuated, and a user would not be able to place his or her foot back into the binding. An upper cap 76 is interconnectable with a standard boot binding 81 (FIG. 5) and includes a plurality of holes 78 (shown in FIG. 2) to be used for attachment of the boot binding to first binding assembly 22. Actuator cover 74 is configured to be trapped beneath upper cap 76. The radiused periphery of actuator cap 74 prevents actuator cover 74 from being pulled fully out through upper cap 76 when actuator cover 74 is placed in the up position.

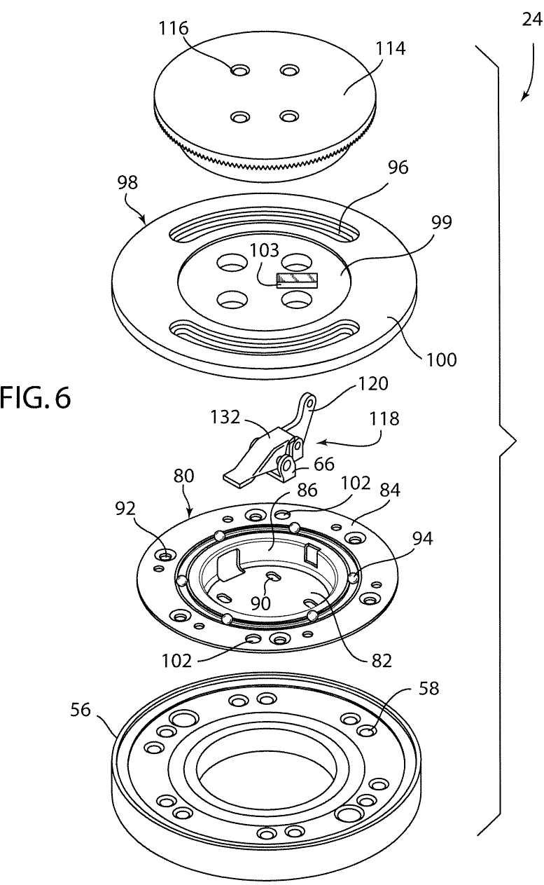

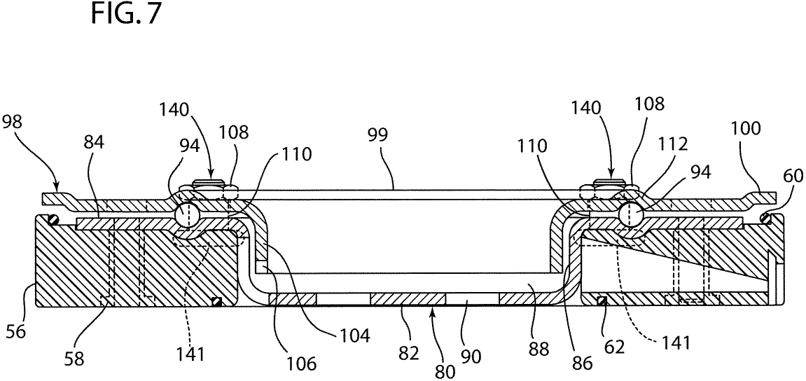

Second binding assembly 24 may include a second base plate 80 having a substantially flat bottom portion 82 and a radially extending and substantially horizontal upper portion 84 connected by a vertically and downwardly extending radial wall 86 as shown in FIGS. 6 and 7. Vertically extending radial wall 86 and bottom portion 82 define a second inner space 88 (FIG. 7). Bottom portion 82 is configured to contact the snowboard and includes a plurality of holes 90 configured to correspond to a typical hole pattern on a snowboard as shown in FIGS. 6 and 7 to allow for attachment to the snowboard. Upper portion 84 includes a plurality of holes 92, and a plurality of ball bearings 94. Plurality of holes 92 corresponds to the positioning of spacer bushings 58 in a second protective spacer assembly 56. Protective spacer assembly 56 is the same as that used in first binding assembly 22 and may be connected to second binding assembly 24 in the same manner as described for the connection of protective spacer assembly 56 in first binding assembly 22.

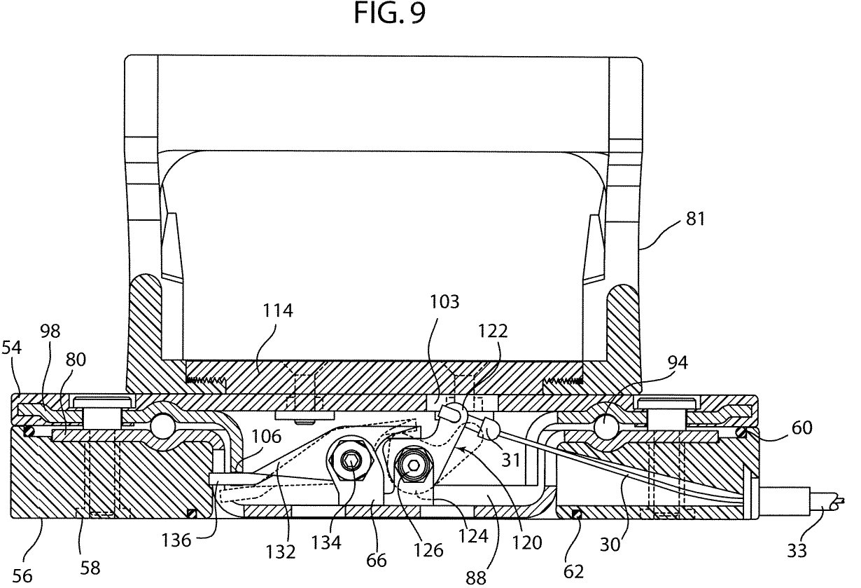

A rotating plate 98 is rotatably connected to upper portion 84 of second base plate 80. Rotating plate 98 includes a radially extending top flange 100, a pair of curvilinear slots 96 and a clearance opening 103 as shown in FIGS. 6 and 9. Rotating plate 98 also includes a vertically extending radial wall 104 that is configured to fit within second inner space 88 and adjacent to vertically extending radial wall 86 of second base plate 80. Radial wall 104 includes a cutout or notch 106 (FIG. 7). Rotating plate 98 may also include an overmold layer 54 the same as top plate 46 in first binding assembly 22.

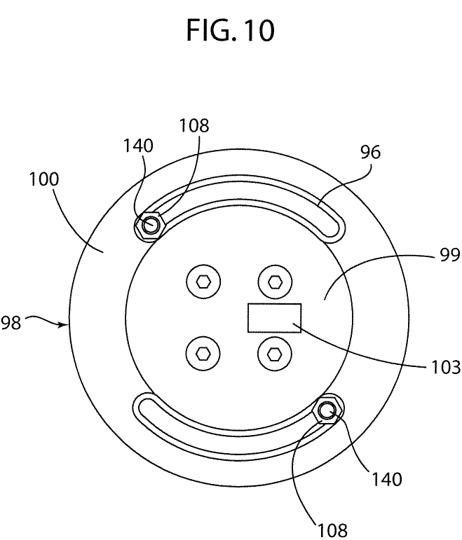

Rotating plate 98 may be attached to upper portion 84 of second base plate 80 with a pair of stop bolts 140 and corresponding nuts 108 as shown in FIGS. 7 and 10. Stop bolts 140 are positioned on opposite ends of the pair of curvilinear slots 96 as shown in FIG. 10 and may include a bottom ledge 141 and a neck portion 110. As best shown in FIG. 7, bottom ledge 141 may be welded to a bottom surface of upper portion 84 such that neck portion 110 extends upwardly through a pair of holes 102 in upper portion 84 (FIG. 6) and through curvilinear slots 96. Nuts 108 may be threadably connected to stop bolts 140 to secure rotating plate 98 to second base plate 80 such that rotating plate 98 is permitted to rotate relative to second base plate 80. Rotating top plate 98 may rotate along a travel path defined by the curvilinear slots 96, which is approximately 90 degrees about an axis perpendicular to top surface 28 of snowboard 26. A bearings raceway 112 may be included on a bottom surface of radial top flange 100 such that ball bearings 94 attached to upper portion 84 will smoothly glide within bearings raceway 112 and assist with rotation of rotating plate 98. Bearings 94 assist the rotation of rotating top plate 98 and provide for a smooth and frictionless movement between second base plate 80 and rotating plate 98.

An upper cover plate 99 is attachable to radial top flange 100 by welding or other known attachment methods and provides a surface to mount a typical boot binding to rotating plate 98. As with first binding assembly 22, a second upper cap 114 is interconnectable with a typical boot binding and includes a plurality of connecting holes 116. Connecting holes 116 are configured to correspond to a plurality of holes 101 in upper cover plate 99 as shown in FIG. 6.

Second base plate 80, rotating plate 98 and upper cover plate 99 may all be constructed of metallic material and preferably stainless steel. However, as with the first binding assembly, any other suitable material may be used that provides the necessary rigidity and durability.

A release mechanism 118 (FIG. 8) is positioned within second inner space 88 as shown in FIG. 9. Release mechanism 118 includes a cam assembly 120 having a connecting arm 122 and a pivoting portion 124. One end of connecting member 30 is connected to arm 122 as shown in FIGS. 8 and 9 in the same manner as the opposite end is connected to actuator assembly 64 (i.e. z-fittings, threaded fasteners, rivets or the like). Pivoting portion 124 is pivotally connected to a second mounting bracket, 66 at a pivot connection 126. Second mounting bracket 66 is attached to bottom portion 82 with welds (arc, mig or resistance), or other known attachment methods. A spring pawl 132 is pivotally connected to second mounting bracket 66 with conventional threaded fasteners about a spring joint 134. Spring pawl 132 includes a lever end 136 configured to move in and out of a notch 106 in rotating plate 98 (FIG. 7) as will be described in more detail below. An extension spring 138 may also be connected on one end to second mounting bracket 66 and on an opposite end to cam assembly 120 as shown in FIG. 8. Extension spring 138 may include a typical coil spring and connected to second mounting bracket 66 with conventional threaded fasteners.

With snowboard binding apparatus 20 mounted to a snowboard, and a set of boot bindings mounted to first and second binding assemblies 22 and 24, a snowboarder may use the snowboard for snowboarding activities. When the user places his feet within the bindings, weight will be exerted upon actuator cover 74 and actuator assembly 64 will place apparatus 20 in a “locked condition.” In the locked condition, second binding assembly 24 will not be able to rotate relative to the snowboard, and a user may snowboard as desired. When in the locked condition, actuator cover 74 forces actuator link 70 downwardly to a folded position as shown in FIG. 4, and pushes connecting member 30 forwardly toward second mounting assembly 24. Connecting member 30 pushes connecting arm 122 of cam assembly 120 upwardly where connecting arm 122 and the end of connecting member 30 are received within clearance opening 103 in rotating plate 98 as shown in FIG. 9. Pivoting portion 124 is then forced to rotate away from spring pawl 132 and release lever 136 will be tipped upward into notch 106 preventing rotating plate 98 from rotating relative to second base plate 80.

When the snowboarder has completed a snowboarding run, and desires to maneuver the snowboard across relatively flat terrain, the user simply removes his back foot from first binding assembly 22. At this point, snowboarding apparatus 20 will be placed in a released or ready to rotate mode. When the weight is removed from upper cap 76 and actuator cover 74, actuator link 70 straightens out or unfolds as shown in FIG. 5, and draws connecting member 30 towards first mounting assembly 22. Connecting member 30 pulls arm 122 of cam assembly 120 downwardly out of clearance opening 103 and allows pivoting portion 124 to rotate into an up position in contact with spring pawl 132. Spring pawl 132 will pivot about spring joint 134 and release lever 136 will move downward and out of notch 106. In this released condition, rotating plate 98 is permitted to rotate relative to second base plate 80 through the travel path defined by curvilinear slots 96. Thus, a snowboarder may rotate his forward foot within the binding relative to the snowboard to an angular orientation that will better accommodate maneuvering the snowboard in a skateboarding fashion.

When the user is ready to resume snowboarding, the user must reposition the orientation of his or her front foot in second binding assembly 24 to a “home position” and into the locked condition preventing rotation of second binding assembly 24. The home position is achieved by reorienting rotating plate 98 such that notch 106 is positioned to receive release lever 136 and clearance opening 103 is positioned to receive arm 122 and the end of connecting member 30. If the home position is not achieved, arm 122 and the end of connecting member 30 will not be able to be pushed upwardly when the user attempts to place weight on top cap 74, because it will interfere with rotating plate 98. Thus, top cap 74 will be in an up position and the user will not be able to step back into first binding assembly 22.

If second binding assembly 24 is properly placed back in the home position, when the user places his or her foot back into first binding assembly 22, connecting member 30 will again push towards second binding assembly 24. The end of connecting member 30 and arm 122 will again move into clearance opening 103. Pivoting portion 124 will be lowered out of contact with the spring pawl 132 and release lever 136 will be placed back into notch 106.

Added benefits of the present invention are the biasing features of extension spring 138 and clock spring 72. Extension spring 138 biases arm 122 into the up position (and pivoting portion 124 downward) into the locked position to ensure that rotating plate 98 will not be able to rotate in the event connecting member 30 is broken. Likewise, clockspring 72 biases lower linkage 68 to the up position preventing the user from placing his foot back into first binding assembly 22. This assures that first binding assembly 22 will not be functional if there is a problem or malfunction with cable assembly 30.

It is to be noted that all components (with the exception of the overmold layer 54) within the snowboard binding assembly may be connected together by either welding, riveting or fastening with threaded fasteners. In addition, while the invention has been described in conjunction with specific embodiments, it is evident that many alternatives, modifications and variations will be apparent to those skilled in the art in light of the foregoing description. Accordingly, the present invention attempts to embrace all such alternatives, modifications and variations that fall within the spirit and scope of the appended claims.

1. A snowboard binding apparatus, comprising:
a first binding assembly including an actuator cover and configured to be attached to a top surface of a snowboard;
a second binding assembly including a rotating plate, said second binding assembly operably connected to said first binding assembly and configured to be connected to said top surface of the snowboard at a spaced longitudinal distance from said first binding assembly; and
wherein said rotating plate is rotatable about an axis perpendicular to said top surface of the snowboard upon removal of weight from said actuator cover, while said first binding assembly remains stationary.

2. A snowboard binding apparatus as defined in claim 1, wherein said first binding
assembly is operably connected to said second binding assembly with a connecting member including a cable

3. A snowboard binding apparatus as defined in claim 1, wherein said
rotating plate includes at least one curvilinear slot, said at least one slot defining the travel path of said rotation of said rotating plate.

4. A snowboard binding apparatus as defined in claim 1, wherein said actuator cover is biased into an up position when no weight is exerted on said actuator cover.

5. A snowboard binding apparatus as defined in claim 4, wherein said actuator cover is biased to said up position with a spring element.

6. A snowboard binding apparatus as defined in claim 1, wherein said first binding
assembly includes a first base plate and said second binding assembly includes a second base plate, said first and second base plates configured to connect to the top surface of the snowboard.

7. A snowboard binding apparatus as defined in claim 6, wherein said rotating plate is connected to said second base plate.

8. A snowboard binding apparatus as defined in claim 7, wherein said second binding assembly includes a release lever operably connected to said first binding assembly.

9. A snowboard binding apparatus as defined in claim 8, wherein said release lever is moveable from a first position to a second position, wherein said first position prevents said rotating plate from rotating and said second position allows said rotating plate to rotate.

10. A snowboard binding apparatus as defined in claim 9, wherein said second binding assembly includes a biasing element configured to bias said release lever into said first position.

11. A snowboard binding apparatus, comprising:
a first binding assembly including an actuator cover and a top plate attached to a first base plate;
a second binding assembly including a rotating plate rotatably connected to a second base plate, said first base plate and said second base plate both configured to attach to a top surface of a snowboard;
a connecting member operably connecting said first binding assembly to said second binding assembly;
wherein said actuator cover is movable from a first position wherein a top surface of said actuator cover is positioned substantially above a bottom of a boot binding connected to said first binding assembly and a second position wherein said top surface of said actuator cover is positioned substantially flush with said bottom of the boot binding; and
wherein said rotating plate is rotatable about an axis perpendicular to said snowboard when said actuator cover is in said first position

12. The snowboard binding apparatus of claim 11, wherein said actuator cover is moved to said second position when a user places weight on said actuator cover.

13. The snowboard binding apparatus of claim 11, wherein said actuator cover is moved to said first position when a user removes weight from said actuator cover.

14. The snowboard apparatus of claim 11, wherein said second binding assembly includes a release lever operably connected to said first binding assembly.

15. The snowboard apparatus of claim 14, wherein said release lever is moveable between a locked position, wherein said release lever is received within a notch in said rotating plate and a released position, wherein said release lever is positioned outside of said notch.

16. The snowboard apparatus of claim 15, wherein said release lever is in said locked position when said actuator cover is in said second position.

17. The snowboard apparatus of claim 15, wherein said release lever is in said release position when said actuator cover is in said first position.

18. The snowboard apparatus of claim 17, wherein said second binding assembly includes a biasing element configured to bias said release lever into said locked position.

19. The snowboard apparatus of claim 11, wherein said actuator cover is biased to said first position with a spring element.

20. A snowboard binding apparatus, comprising:
a first binding assembly including a first base plate and an actuator cover, said first base plate configured to be attached to a top surface of a snowboard;
a second binding assembly including a second base plate and a release lever, said release lever operably connected to said first binding assembly and said second base plate configured to be attached to the top surface of the snowboard at a longitudinally spaced distance from said first base plate;
a connecting member operably connecting said first binding assembly to said second binding assembly; and
wherein said second binding assembly further includes a rotating plate, said rotating plate rotatable about an axis perpendicular to the top surface of the snowboard upon removal of weight from said actuator cover.

21. The snowboard binding apparatus of claim 20, wherein said rotating plate includes a pair of curvilinear slots that define the travel path of rotation of said rotating plate.
